(19) United States
(12) Patent Application Publication
(10) Pub. No.: US 2010/0154582 A1
(43) Pub. Date: Jun. 24, 2010

(54) DEVICE FOR ACTUATING A CLUTCH PEDAL

(75) Inventor: Jean-Luc Malcuy, Sartrouville (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE BILLANCOURT (FR)

(21) Appl. No.: 12/666,553

(22) PCT Filed: May 28, 2008
(86) PCT No.: PCT/FR08/50925

§ 371 Date: Jan. 28, 2010

(30) Foreign Application Priority Data
Jun. 27, 2007 (FR) 0704602

(51) Int. Cl. G05G 1/44; G05G 1/30; B60K 23/02

(52) U.S. Cl. 74/512

(57) ABSTRACT

An automotive construction device including a spring system that normally exerts a moment on a pedal that keeps it in a stable upper clutch-engaged position, the spring being inserted between a connection point fixed to the pedal and another connection point borne by an element fixed to a vehicle chassis, the driver of the vehicle releasing the clutch by pivoting the pedal in a downward direction, firstly against the resistance of the spring and then, beyond a given pegging angle, with aid of the spring. At least one of the two connection points is mounted movably with respect to the element to which it is fixed, and the device automatically shifts the connection point at the end of the clutch-release travel so as to substantially reduce the moment exerted by the spring on the pedal in the clutch-release direction.

The present invention concerns a device for assisting with actuation of a vehicle, in particular automobile vehicle, pivoting clutch pedal.

Some automobile vehicle drive trains are able to generate high engine torques, which can exceed 300 N.m. In a correlated manner, the clutch mechanisms developed to transmit the engine torque to the driving wheels demand the application of high forces, which is difficult to make compatible with the physical capabilities of the driver and the required ergonomics, corresponding to the forces to be applied to the clutch pedal and its travel.

This force must be exerted by the driver of the vehicle to release the clutch by depressing the pedal with their foot to pivot it downward.

To engage the clutch, the driver releases the pressure, with the result that the pedal returns to its initial high position. This pivoting in the opposite direction is driven by the action of springs of the clutch mechanism, possibly with the assistance of an additional dedicated spring.

Assistance devices using springs that reduce the force that the driver must exert on the pedal to disengage the clutch have already been proposed (see for example FR 2 458 433).

Such a device must provide a number of functions.

Firstly, it must not compromise, and to the contrary must preferably favor, the pedal remaining in its natural high clutch-engaged position. Ideally this position must be secure, clearly defined and stable.

Secondly, the assistance force must be correlated with the force developed by the clutch mechanism, which the driver has to overcome during the clutch disengagement stroke.

Thirdly, and finally, the force developed by the assistance device at the end of the clutch disengagement stroke must not be too high, so as not to impede the clean, secure and fast return of the pedal to its initial clutch engaged position as soon as the driver removes the pressure on it.

The invention aims to satisfy these various objectives, which is a problem in terms of their compatibility.

To this end, the device of the invention includes a spring system which normally exerts a moment on the pedal that keeps it in a stable upper clutch-engaged position, this first spring being inserted between a first connection point fastened to the pedal and a second connection point carried by an element fastened to the vehicle chassis, the driver of the vehicle disengaging the clutch by pivoting the pedal in a downward direction, firstly against the resistance of said spring and then, secondly, beyond a given heel angle, with the aid of said spring.

Accordingly, beyond the heel angle, the spring retains the pedal positively, in a secure and stable manner, in its natural top position.

The device is characterized in that at least one of said connection points is mounted movably with respect to the element to which it is fastened and in that it includes means for shifting this connection point automatically at the end of the clutch-disengagement travel so as significantly to reduce the moment that the spring exerts on the pedal in the clutch-disengagement direction.

Thanks to this arrangement, the moment that opposes subsequent return of the pedal to the initial position is reduced in the first phase of its return.

Moreover, according to a number of possible additional features of the invention, although these features are not limiting on the invention:

said first spring is a compression spring;

said mobile connection point is carried by a pivoting member loaded by a second spring;

this second spring is a traction spring;

said pivoting member is articulated about a pin fastened to the chassis of the vehicle and has two angularly offset bearing facets, one or the other of which is adapted to abut against a stop pin also fastened to the chassis of the vehicle, and the first spring loads the pivoting member into an armed position in which one facet abuts against the stop pin when the pedal is in its high clutch-engaged position whereas the second spring constantly causes it to pivot into a retracted position in which the other facet abuts against the stop pin;

the device includes mechanical automatic rearming means;

the upper part of the pedal includes a protruding portion, possibly provided with a driving pin, and said pivoting member includes an appendix, the trajectory of said protruding portion being adapted not to interfere with said appendix when the pedal pivots downward and the pivoting member is in its armed position and, to the contrary, in order to interfere with said appendix when the pedal pivots upward toward its natural clutch-engaged position and the pivoting member is in its retracted position, so as thereby to return the pivoting member to its armed position;

said pivoting member is articulated about a pin fastened to the pedal and is adapted to abut against two angularly offset bearing portions also fastened to the pedal, the first spring loading the pivoting member into an armed position in which it abuts against a bearing surface when the pedal occupies its high and clutch-engaged position and the second spring constantly causes it to pivot into a retracted position in which the pivoting member abuts against the other bearing surface;

the device includes a fixed rearming pin fastened to the chassis of the vehicle and said pivoting member has an actuator appendix adapted not to interfere with the rearming pin when the pedal pivots downward and the pivoting member is in its armed position and, to the contrary, to interfere with said pin when the pedal pivots upward toward its natural clutch-engaged position and the pivoting member is in its retracted position, so as thereby to return the pivoting member to its armed position;

it includes electrical automatic rearming means.

Other features and advantages of the invention will become apparent on reading the following description referring to the appended drawings, in which:

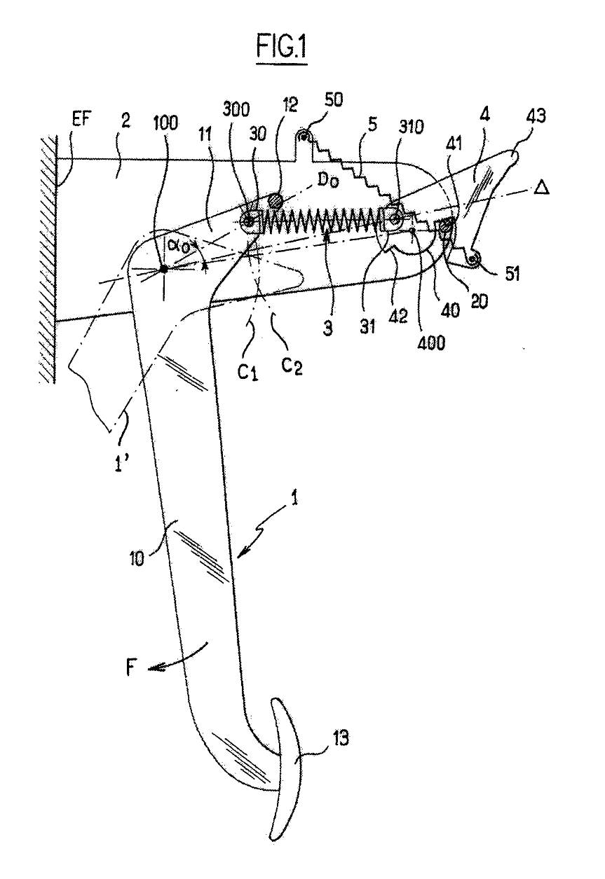

FIG. 1 represents diagrammatically a clutch pedal equipped with an assistance device of the invention, this pedal occupying its normal high position (clutch-engaged position).

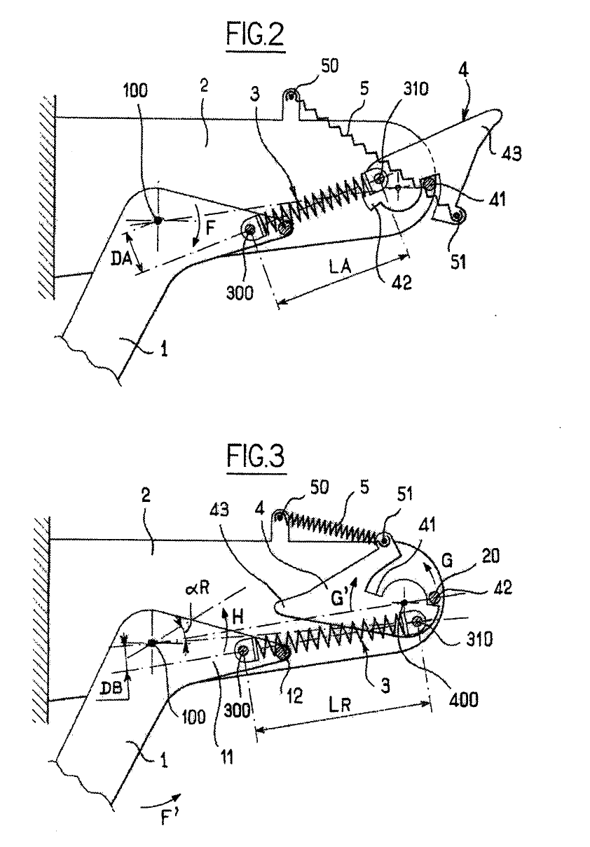

FIGS. 2 and 3 are partial views similar to that of FIG. 1 showing the same pedal near the end of its downward stroke, respectively before and after displacing the pivoting member from its armed position to its retracted position.

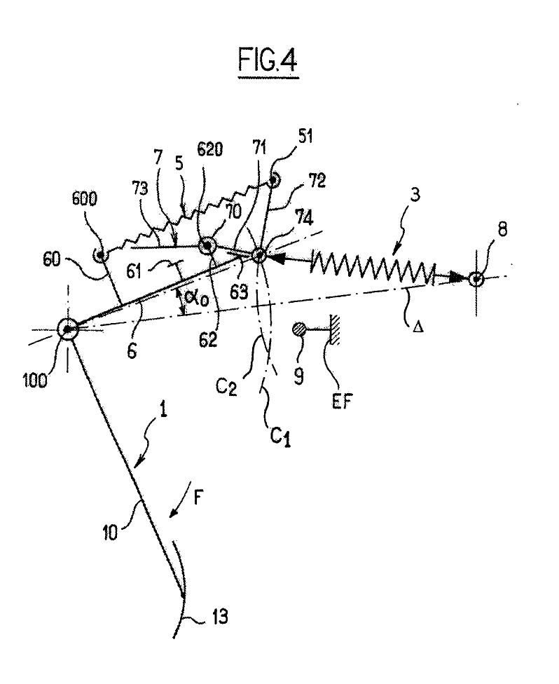

FIG. 4 represents even more diagrammatically a clutch pedal equipped with an assistance device conforming to another possible embodiment of the invention, this pedal occupying its normal high position (clutch-engaged position).

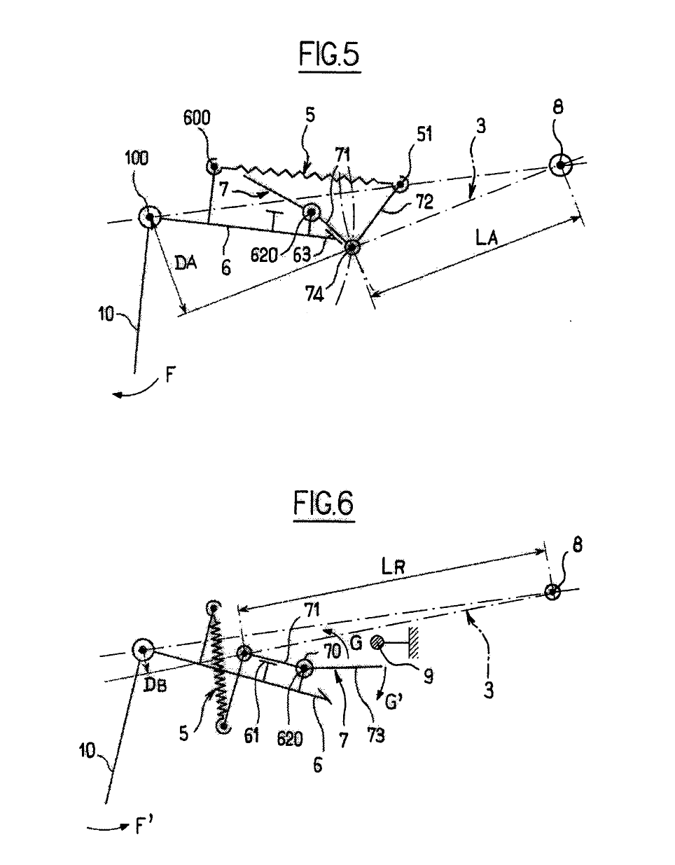

FIGS. 5 and 6 are partial views similar to that of FIG. 4 showing the same pedal in the vicinity of the end of its downward stroke, respectively before and after the pivoting member moves from its armed position to its retracted position.

In FIG. 1 the reference 1 represents a clutch pedal equipping an automobile vehicle.

It has a rectilinear main part 10 slightly inclined to the vertical. It is cranked in its upper part to form an oblique arm 11 and is provided in its lower part with a pad 13 enabling it to be actuated by the foot.

The arm 11 forms a protruding portion provided with a pin 12 the function of which is explained hereinafter.

This pedal is articulated about a pin 100 in its upper portion, in the region of its cranked area. The latter pin is mounted between the two flanges of a yoke 2 fastened to a fixed element EF of the chassis of the vehicle.

By depressing the pad 13 with their foot, the driver can pivot the pedal downward about the pin 100 in the direction symbolized in FIG. 1 by the arrow F as far as the position 1′ represented in chain-dotted line.

The kinematic connecting means between the pedal and the clutch mechanism, which can be of any known type, and likewise this mechanism, are not shown here.

The position 1′ of the pedal corresponds to the clutch-disengaged position of this mechanism, which is effected with a view to changing gear.

The pedal is held in its normal (clutch-engaged) position by a prestressed compression coil spring 3, called the first spring, which is disposed between two bearing and retaining parts 30, 31.

The part 30 is mounted on a journal 300 that serves as a first connecting point and is carried by the pedal arm 11.

The part 31 is mounted on a journal 310 that serves as a second connecting point and is carried by a pivoting part 4.

The part 4 is articulated about a pin 400 carried by the yoke 2. This part, as seen in FIG. 1, has a triangular general shape, one side of which has a semicircular notch 40 centered on the pin 400 and delimited by radial facets 41, 42. One of its corner areas has an elongate portion forming an appendix 43.

A fixed stop rod or pin 20 carried by the yoke 2 limits the amplitude of pivoting of the part 4 about the pin 400 to an angle corresponding to the sector 40, i.e. slightly less than 180°.

At the end of the pivoting stroke one or the other of the facets 41, 42 bears against the pin 20.

A traction spring 5 (second spring) is disposed between a fixed attachment point 50 (fastened to a flange of the yoke 2) and an attachment point 51 carried by the part 4.

In FIG. 1 the reference Δ designates the straight line segment passing through the pin 100 of the pedal and the second connecting point 310.

D₀ designates straight line segment passing through the pin 100 and the first connecting point 300.

The straight line segments D₀ and Δ form between them an acute angle α₀ called the “heel angle”.

It is clear from this figure that the first spring 3, which works in compression and is prestressed, acts on the arm 11 (via the connecting point 300) in such a manner as to exert on the pedal 1 a moment to return it to its stable high position. That position can be determined by a top end of travel abutment (not shown) against which an element fastened to the pedal comes to bear. At the same time, this spring 3 also acts on the part 4 (via the connecting point 310) to cause it to pivot about its pin 400 in such a manner as to press the facet 41 against the stop pin 20.

This is explained by the fact that the line of action of the spring 3 passes above the axes 100 and 400.

On the other hand, the second spring 5, which works in traction, because its line of action also passes over the pin 400, causes the part 4 to pivot in the opposite direction.

The dimensions and positions of the various members of the device are such that the moment exerted by the spring 3 on the part 4 is higher than that exerted in the opposite direction by the spring 5.

The configuration shown in FIG. 1 is therefore obtained, in which the appendix 43 on the part 4 is directed upward and outward relative to the pedal 1.

In FIG. 1, C₁ designates the circular trajectory of the connecting point 300 about the pin 100 and C₂ the virtual (theoretical) circular trajectory of that same point about the connecting point 310.

It is seen that these two trajectories interfere in a first phase, after which they move away from each other. Their maximum separation corresponds to crossing the straight line segment Δ at the end of the heel stroke.

How clutch disengagement is effected starting from the FIG. 1 high position is explained next with reference to FIGS. 1 to 3.

The driver actuates the pedal to cause it to pivot in the direction F. During the heel stroke, through the angle α₀, this movement causes compression of the first spring 3 because of the interference between trajectories referred to above. However, the additional force to be overcome is not a problem in practice because the resistance of the spring(s) of the clutch mechanism is moderate at the outset.

Beyond the heel stroke, the spring 3 progressively relaxes, and its orientation is such that its line of action passes under the pin 100. In FIG. 2 the corresponding lever arm is reference D_{A}.

Accordingly, the spring 3 exerts on the pedal 1 a pivoting moment in the direction F, i.e. in the same direction as that applied by the driver.

The driver is therefore assisted in applying this force by the action of this spring 3.

From the end of the heel stroke, as far as a position close to the end of the stroke of the pedal in the direction F, the progressive relaxation (expansion) of the spring 3 leads to a proportionate reduction in the force that it develops; however, at the same time the lever arm D_{A} increases, and so the assistance moment remains substantially constant or even increases.

During this second phase, the moment exerted by this same spring 3 on the part 4 remains sufficient to oppose the antagonistic moment developed by the second spring 5, and the part 4 remains fixedly in its initial armed position.

However, in the vicinity of the end of the stroke of the pedal 1, the spring 3 has expanded to such a degree that it can no longer counter the action of the spring 5.

The latter spring then causes the pivoting of the part 4 symbolized by the arrow G in FIG. 3 until the other facet 42 comes to bear against the stop pin 20.

The FIG. 3 configuration is then obtained, in which the part 4 is in the retracted position.

As can be seen in this figure, the second connecting point 310 as in particular moved outward as a result of the change of orientation of the part 4. This has resulted in a net increase in the mutual separation of the two connecting points 300, 310.

The value of this separation, designated L_{A} in FIG. 2, has increased to L_{R}, with L_{R}>L_{A}.

This corresponds to expansion of the spring 3 and thus reduction of its force.

Furthermore, the change of orientation of the part 4 has caused lowering of the connecting point 310, which has modified the direction of the line of action of this spring, the lever arm D_{B} of which has a value lower than D_{A}.

The moment exerted by the spring 3 on the pedal 1 in the direction F, which is the product of the force by the lever arm, is therefore significantly less than that which preceded the change of orientation of the part 4.

Thanks to the reduction in the force that urges it in the direction F, as soon as the driver stops actuating the pedal 1 the pedal can pivot cleanly and securely in the opposite direction because of the action of the elastic system internal to the clutch mechanism.

The latter pedal then pivots upward as symbolized by the arrow F′ in FIG. 3.

The upper pedal portion 11, the pin 12 with which it is provided and the appendix 43 of the part 4 have dimensions and positions such that as it rises the pin encounters the appendix 43 and entrains it as it continues to move, causing the part 4 to pivot in the direction G′ opposite to G.

The part 4 thus returns to its initial armed position and the pedal returns to its FIG. 1 clutch-engaged position.

The second embodiment shown in FIGS. 4 to 6 works overall in accordance with the same principle as that which has just been described.

It is distinguished from the latter embodiment essentially in that the pivoting part that modifies the moment exerted on the pedal is articulated to the latter pedal and not to a fixed element of the chassis.

The references used for this second embodiment have been retained to designate elements functionally identical or similar to those of the first embodiment.

The description is given first with reference to FIG. 1, in which the pedal 1 is in it natural high position (clutch-engaged position) and the pivoting part is in the armed position.

This pedal has a cranked shape comprising a rectilinear arm 6 that forms an angle close to a right angle with its main part 10, the articulation pin 100 being located in the area of the elbow connecting these two elements.

The arm 6 carries, directed upward, on moving outward from the pin 100:
a lug 60 the free end 600 of which constitutes an attachment point of the second (traction) spring 5;
a first bearing surface 61 substantially parallel to the arm 6;
a lug 62 carrying an articulation pin 620;
a second bearing surface 63 slightly inclined downward and outward relative to the direction of the arm 6.

The pivoting part 7 includes a bearing 70 by means of which it is mounted on the arm 6 and articulated about the pin 620 referred to above.

This part 7 includes, externally relative to the bearing 70, an arm 71 that bears against the bearing surface 63. Its other end is cranked at approximately a right angle, having a branch 72 directed upward. The free upper end of this branch 72 constitutes the second attachment point 51 of the spring 5.

At the level of the elbow between the arm 71 and the branch 72, the part 7 is provided with a journal 74 that constitutes one of the two connecting points of the compression spring 3.

Its other connecting point 8 is a journal carried by a fixed element of the chassis.

On the other side of the bearing 70 there is an appendix 73 which rearms the part 7, as explained hereinafter.

This appendix is in a position offset transversely to the plane of the drawing relative to the arm 6 and to the bearing surfaces 61-63, with the result that it cannot interfere with those elements when the part 7 pivots about the pin 620.

The device includes a fixed rearming pin 9 positioned in the same transversely offset plane as the appendix 73.

Note that the pin 9 is not represented in FIG. 5 in order not to overcomplicate it unnecessarily. For the same reason, only the pin of the spring 3 is shown in FIGS. 5 and 6, not the spring itself.

The first spring 3 inserted between the fixed point A and the journal 74 acts on the latter journal, both directly to urge the part 7 to rotate about the pin 620 and indirectly (via the arm 71 and the bearing surface 63) to urge the pedal 1 to rotate about the pin 100.

In the initial position (FIG. 1), the line of action of the spring 3 passes below the pin 620 and thus exerts on the part 7 a moment that retains it in its armed position, with the arm 71 pressed against the bearing surface 63. The traction force exerted on the branch 72 by the spring 5 is insufficient to counter this moment.

This line of action passes above the pin 100 and therefore tends to maintain the pedal 1 in a stable and secure manner in its high, clutch-engaged position.

During the downward pivoting stroke of the pedal, which corresponds to disengaging the clutch (arrow F, FIG. 5), beyond the heel angle, and as in the first embodiment, the spring 3 provides assistance by increasing the lever arm designated D_{A} in FIG. 5.

The part 7 remains in the armed position.

The transversely offset pin 9 does not impede the passage of the device.

At the end of the downward stroke of the pedal, or just before this, the spring 3 has relaxed to the point that the moment it exerts on the part 7 becomes insufficient to counter the antagonistic moment of the spring 5.

The part 7 is then seen to pivot about the pin 620 until its arm 71 abuts against the bearing surface 61 (arrow G, FIG. 6).

After this change of orientation, which corresponds to turning through practically 180°, the end portion of the actuator appendix 73 is positioned under the fixed rearming pin 9.

Furthermore, the change of orientation of the part 7 has caused the connecting point 74 to be raised, which has modified the direction of the line of action of the spring 3, the lever arm D_{B} of which has a lower value than D_{A}.

The moment exerted by the spring 3 on the pedal 1 in the direction F, which is the product of the force by the lever arm, is therefore significantly less than that preceding the change of orientation of the part 7.

Thanks to this reduction of the force that urges it in the direction F, the pedal 1 can pivot cleanly and securely in the opposite direction, because of the action of the internal spring system of the clutch mechanism, as soon as the driver stops actuating the pedal.

The latter pedal therefore pivots upward, as symbolized by the arrow F′ in FIG. 6.

The appendix 73 encounters the pin 9, which causes the part 7 to pivot in the direction G′ opposite to G.

The part 7 thus returns automatically to its initial armed position and the pedal returns to its FIG. 4 clutch-engaged position.

It is possible to use an electrical control system instead of a mechanical automatic arming and/or rearming system, both in the first embodiment and in the second.

On this assumption, the mobile part 4, 7 is equipped with sensors to detect its angular position relative to the yoke 2, respectively the arm 6, and the direction of movement of the pedal 1.

Signals representative of the situation are sent to a computer adapted to command an electric actuator in order for it to exert on the mobile part sufficient torque to arm it or return it to its initial armed position.

This actuator can in particular be an electric motor or an electromagnet.

1-10. (canceled)

11. A device for assisting with actuation of a vehicle pivoting clutch pedal, comprising:
a spring system that normally exerts a moment on the pedal that keeps the pedal in a stable upper clutch-engaged position, the first spring being inserted between a first connection point fastened to the pedal and a second connection point carried by an element fixed to the vehicle chassis, the driver of the vehicle disengaging the clutch by pivoting the pedal in a downward direction, firstly against resistance of the spring and then, secondly, beyond a given heel angle, with aid of the spring,
wherein at least one of the two connection points is mounted movably with respect to the element to which it is fastened and includes means for shifting this connection point automatically at the end of a clutch-disengagement travel so as significantly to reduce a moment that the spring exerts on the pedal in the clutch-disengagement direction.

12. The device claimed in claim 11, wherein the first spring is a compression spring.

13. The device claimed in claim 11, wherein the mobile connection point is carried by a pivoting member loaded by a second spring.

14. The device claimed in claim 13, wherein the second spring is a traction spring.

15. The device claimed in claim 13, wherein the pivoting member is articulated about a pin fastened to the chassis of the vehicle and includes two angularly offset bearing facets, one or the other of which is adapted to abut against a stop pin also fastened to the chassis of the vehicle, and the first spring loads the pivoting member into an armed position in which one facet abuts against the stop pin when the pedal occupies its high clutch-engaged position whereas the second spring constantly causes it to pivot into a retracted position in which the other facet abuts against the stop pin.

16. The device claimed in claim 11, further comprising mechanical automatic rearming means.

17. The device claimed in claim 15, wherein the upper part of the pedal includes a protruding portion, or a protruding portion including a driving pin, and the pivoting member includes an appendix, a trajectory of the protruding portion being adapted not to interfere with the appendix when the pedal pivots downward and the pivoting member is in its armed position, and to interfere with the appendix when the pedal pivots upward toward its natural clutch-engaged position and the pivoting member is in its retracted position, so as thereby to return the pivoting member to its armed position.

18. The device claim in claim 13, wherein the pivoting member is articulated about a pin fastened to the pedal and is adapted to abut against two angularly offset bearing portions also fastened to the pedal, the first spring loading the pivoting member into an armed position in which it abuts against a bearing surface when the pedal occupies its high and clutch-engaged position and the second spring constantly causes it to pivot into a retracted position in which the pivoting member abuts against the other bearing surface.

19. The device claimed in claim 16, further comprising a fixed rearming pin fastened to the chassis of the vehicle whereas the pivoting member includes an actuator appendix adapted not to interfere with the rearming pin when the pedal pivots downward and the pivoting member is in its armed position, and to interfere with the pin when the pedal pivots upward toward its natural clutch-engaged position and the pivoting member is in its retracted position, so as thereby to return the pivoting member to its armed position.

20. The device claimed in claim 11, further comprising electrical automatic rearming means.
